(19) United States
(12) Patent Application Publication
(10) Pub. No.: US 2007/0053403 A1
(43) Pub. Date: Mar. 8, 2007

(54) Laser cavity pumping configuration

(75) Inventor: Alan M. Cox, Cheshire (GB)

Correspondence Address: SMYRSKI LAW GROUP, A PROFESSIONAL CORPORATION, 3310 AIRPORT AVENUE, SW, SANTA MONICA, CA, 90405, US

(73) Assignee: Laser Quantum Ltd.

(21) Appl. No.: 11/510,354

(22) Filed: Aug. 25, 2006

(30) Foreign Application Priority Data
Sep. 2, 2005 (GB) 0517863.7

(51) Int. Cl. H01S 3/08

(52) U.S. Cl. 372/92

(57) ABSTRACT

A laser cavity includes at least a first mirror and a second mirror, at least one gain medium located on an optical path between said mirrors, and an optical waveguide for providing pump light. A beam splitter is arranged to split the pump light from the optical waveguide into at least a first portion and a second portion, and direct each portion along an optical path that leads into a respective, different, face of the at least one gain medium.

This application claims priority based on British Patent Application No. 0517863.7. entitled “Laser Cavity Pumping Configuration,” by Alan M. Cox, filed on Sep. 2, 2005, the entirety of which is incorporated herein by reference.

### BACKGROUND OF THE INVENTION

1. Field of the Invention

The present invention relates to a laser cavity pumped via an optical waveguide, to devices incorporating such laser cavities, and to methods of manufacturing such laser cavities.

2. Description of the Related Art

Over the last decade, diode-pumped solid-state (DPSS) laser systems have become increasingly popular in many industrial applications. DPSS lasers consist of at least one solid state laser gain medium (e.g. a “lasing crystal” or “laser crystal”) that is pumped by one or more diode lasers. DPSS lasers are relatively compact and efficient, and have replaced both lamp pumped and gas discharge laser systems in many applications.

Early diode end-pumped solid-state lasers were limited in power due to the relatively low brightness of the available diode lasers. Such DPSS lasers consisted mainly of single-stripe diode laser pumped systems, typically providing an output of around a Watt or less of infrared light (or around half that for frequency-doubled lasers). Although laser diodes in the form of diode bars were capable of delivering higher powers than single-stripe diode lasers, the technology to reformat the highly asymmetric output into a more symmetrical shape for use in end-pumping lasers was in its infancy.

More recently, laser diode technology has improved to give outputs of much higher brightness. Further, the technology to reformat the output light in to a more symmetrical shape without sacrificing as much of the power has also improved. This has enabled laser designers to increase the output power of DPSS lasers to many tens of Watts in the fundamental wavelength in a TEM₀₀ mode. In many cases, the available brightness of the light from the laser diode is no longer the major technical hurdle in power scaling (increasing the output power of) diode pumped solid-state lasers. Careful thermal design to efficiently remove excess heat has become much more important, as well as careful control of the thermal lensing within the laser gain medium, especially within fundamental spatial mode (TEM₀₀) systems.

One known method of power scaling such a DPSS laser system is to focus pump light into both ends of the laser gain medium at the same time. This “double-end” pumping allows for more absorbed pump power within the gain medium before approaching the thermal fracture limit of the gain medium (e.g. the laser crystal).

It is also known that the laser diode ‘pump’ light can be launched into an optical fibre, before being focussed into the laser gain medium. This “fibre-pump” method has two advantages;
1) The light emitted from the optical fibre is likely to be more cylindrically symmetric in profile than the light entering the fibre, leading to a cylindrically symmetrical thermal lens with typically lower aberration.
2) The pump diode and its waste heat can be physically separated from the laser head/cavity, leading to a smaller laser head, which dissipates less heat.

One disadvantage of this fibre-pump method is that the output light from the fibre is likely to be less polarised than the input light, and the polarisation state of the output light will change as the optical fibre is moved around e.g. due to vibrations. This can lead to fluctuations in the output of the DPSS laser if, for instance, the laser gain medium is a birefringent crystal and has different absorption coefficients along different crystallographic axes.

DPSS laser systems using double-end pumping in conjunction with fibre-coupled pumping are known, that incorporate two separate laser diode units launched into two separate optical fibres. The output of each of the fibres is then focussed into opposite ends of the laser gain medium. This method can lead to outputs of tens of Watts of fundamental wavelength or over 10 Watts of frequency doubled light in a TEM₀₀ mode. However, the laser output power may still vary as the optical fibres are reoriented.

### SUMMARY OF THE INVENTION

According to a first aspect of the present invention there is provided a laser cavity comprising: at least a first mirror and a second mirror, at least one gain medium located on an optical path between said mirrors, an optical waveguide for providing pump light, and at least one beam splitter arranged to split the pump light from the optical waveguide into at least a first portion and a second portion, and direct each portion along an optical path that leads into a respective, different, face of said at least one gain medium.

This arrangement facilitates the power-scaling of a laser cavity by spreading the thermal loading due to the pump light incident on the laser gain medium over more than one surface of one or more laser gain medium(s). The overall effect of thermal lensing can be reduced, whilst the pump light can be supplied via a single optical waveguide such as an optical fibre, thus potentially reducing cost and complexity in the manufacturing process.

Said first and second portions of the pump light may be directed into opposing surfaces of one of said at least one gain medium.

One of said portions of the pump light may be directed into a surface of a first gain medium, and another of said portions may be directed into a surface of a second gain medium.

Said beam splitter may be a polarising beam splitter arranged to split the pump light into the first portion having a first polarisation, and the second portion having a second, different polarisation.

The cavity may comprise another optical waveguide arranged to transport at least one of said portions of said pump light for directing that portion into said one of said faces.

The cavity may comprise a further pump optical waveguide for providing a further pump light to the laser cavity, said at least one beam splitter being arranged to split this further pump light into at least a further two portions, and direct each of these further portions along an optical path into a respective, different face of said at least one gain medium.

One of said gain medium may be a birefringent crystal having a first axis with a first absorption coefficient, and a second axis with a second, different absorption coefficient for the pump light.

Said birefringent crystal may be doped with at least one of Neodymium and Ytterbium, and the birefringent material may comprise at least one of: YVO₄, GdVO₄, and YLF.

The cavity may comprise a non-linear frequency doubling crystal arranged to frequency double the fundamental laser light output by the gain medium.

In a second aspect the present invention provides an apparatus comprising a laser cavity as described above.

The apparatus may comprise a second laser, and the laser cavity may be arranged to provide an output beam for pumping the second laser.

According to a third aspect of the present invention there is provided a method of manufacturing a laser cavity comprising: providing at least a first mirror and a second mirror, providing at least one gain medium located on an optical path between said mirrors, providing an optical waveguide for providing a pump light, locating at least one beam splitter to split the pump light from the optical waveguide into at least a first portion and a second portion, and to direct each portion along an optical path that leads into a respective, different face of said at least one gain medium.

The method may comprise adjusting the polarisation of at least one of the portions of the pump light incident upon said gain medium, for optimising the average absorption depth of the pump light within the gain medium.

The polarisation may be adjusted by altering the orientation of a wave-plate within the optical path of said portion.

Said gain medium may comprise a birefringent crystal, and the method may comprise configuring the polarisation of two portions of said pump light incident upon opposite surfaces of the crystal, so as to have the same proportion of components along the a-axis and c-axis of the crystal, the portions thereby experiencing the same average absorption depth within said crystal.

Said gain medium may comprise a birefringent crystal, and the method may comprise configuring the polarisation of one of said portions of the pump light incident upon a surface of the crystal to be substantially parallel to at least one of the a-axis and the b-axis of the crystal, thereby maximising the absorption depth of that portion within said crystal.

### DESCRIPTION OF THE DRAWINGS

Specific embodiments of the invention will now be described by way of example only, with reference to the accompanying drawings, in which:

FIG. 1a is a schematic diagram of a double-end-pumped laser cavity, in which the pump light is provided by a single optical fibre in accordance with a first embodiment of the present invention;

FIG. 1b is a schematic diagram of a laser cavity generally similar to that illustrated in FIG. I a, with the addition of a non-linear frequency doubling crystal for halving the wavelength of the cavity output light, in accordance with a further-embodiment of the present invention;

FIG. 2 is a schematic diagram of an alternative embodiment of a double-end-pumped laser cavity, with pump light being provided by a single optical fibre;

FIG. 3 is a schematic diagram of another embodiment of a double-end-pumped laser cavity, with pump light being provided to the cavity by a single optical fibre, and incorporating a second optical fibre for directing a portion of the pump light into a face of the laser gain medium; and

FIG. 4 is a schematic diagram of a laser cavity in accordance with a further embodiment of the present invention, including two gain media, each being double-end-pumped with pump light from a single optical fibre.

### DETAILED DESCRIPTION OF THE INVENTION

Described herein is a simplified laser cavity arrangement. Pump light originating from one optical waveguide (e.g. optical fibre) is split into two portions. Each portion is then directed into a different face of at least one gain medium. The portions can be directed into different (e.g. opposite) faces of a single gain medium, or each portion can be directed into a separate gain medium. Pump light directed into the waveguide can originate from one or more pump lasers e.g. one or more diode lasers.

Such a cavity geometry allows pump light to be introduced into two or more surfaces of a laser gain medium, but with pump light only being provided to the laser head via one optical waveguide. Application of this geometry can reduce manufacturing costs.

Further, relatively high powers of pump light can be provided to the laser cavity via an optical waveguide, with the high power pump light being split into two portions of lower power for entering different surfaces of the laser gain medium (media). Thus, thermal aberration effects can be reduced in the laser gain medium/media, whilst still only utilising one optical fibre to provide the relevant pump light.

In preferred embodiments, output from the waveguide is split into two polarised beams of light, preferably with orthogonal polarisations. For example, this can be achieved by use of a polarising beam splitter.

Light output from optical waveguides such as optical fibres is typically relatively unpolarised. Thus, in prior art devices, typically the output power of the laser varies significantly with changes to the orientation of the optical fibre leading to a change in the polarisation components of the pump light output from the fibre.

Many laser gain media are crystalline e.g. they typically consist of a crystalline host doped with the actual active lasing atoms or ions. Different axes of the crystal can have different absorption coefficients. For example, in a uniaxial crystal such as Nd:YVO₄, pump light incident with polarisation components parallel to the a-axis or b-axis of a crystal will be subject to a lower absorption coefficient than pump light incident with polarisation components parallel to the c-axis of the crystal. Thus, in typical prior art devices, as the polarisation components of the pump light output from the waveguide alter, the total amount of the pump light absorbed by the lasing crystal can also correspondingly alter, due to different axes having different absorption coefficients. This leads to a corresponding alteration in the power output from the lasing crystal, and thus the total power output from the solid state laser.

However splitting the pump light into polarised, orthogonal beams as described herein, can reduce/remove the effect on laser power output due to changes in waveguide orientation. Splitting the pump light out from the optical waveguide into two orthogonal polarisations, allows alignment of each polarisation with (or at an equal predetermined angle relative to) a predetermined axis of the crystalline gain medium. Thus, the total laser output power can be relatively insensitive to fibre orientation, as the shift in fibre orientation will only change the relative pump power incident on each surface of the lasing crystal (as opposed to altering the axis being pumped within the lasing crystal) as the polarisation components output from the fibre change.

Further, splitting the pump light into two polarisation states allows the polarised states to be easily controlled to be aligned with, or at a predetermined angle relative to, the axes of the lasing crystal. If desired, the polarisation of each of the polarised beams can be rotated to provide the desired alignment e.g. by using a half-wave-plate.

For example, if the gain medium is birefringent, then the polarisation of each of the beams can be arranged such that only the a-axis or c-axis are pumped, or a combination of both the a-axis and c-axis are pumped in order to optimise the average absorption depth experienced by each polarised beam.

For example, the polarised pump portions can each be aligned parallel to the a-axis or b-axis within uniaxial crystals (e.g. Nd:YVO₄ or Nd:GdVO₄) if a long absorption depth is required. Such pump light will experience a lower absorption coefficient (and hence a longer absorption depth), than light polarised parallel to the c-axis (due to the c-axis having a higher absorption coefficient). Relatively long absorption depths are desirable in many applications, including high powered pumping. In prior art devices, long absorption depths are typically achieved by utilising bespoke extra-low dopant laser crystals. However, by utilising and appropriately aligning the polarisations of the pump light as described herein, the desired relatively long absorption depths within the crystal can be achieved, without requiring the use of expensive bespoke crystals.

In alternative applications, the average absorption depth of the pump light can be adjusted (e.g. by rotating the polarisation of each of the polarised portions of pump light), so as to optimise the laser performance.

Various embodiments will now be described, with reference to the accompanying Figures. Within the Figures, similar features are identified using identical reference numerals. Solid arrows are utilised to indicate the direction of pump light. Dotted arrows are utilised to indicate the direction of laser light originating from the solid state laser gain medium.

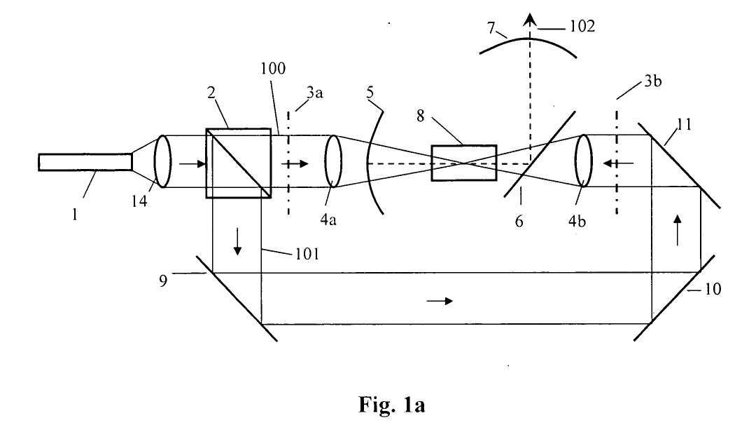

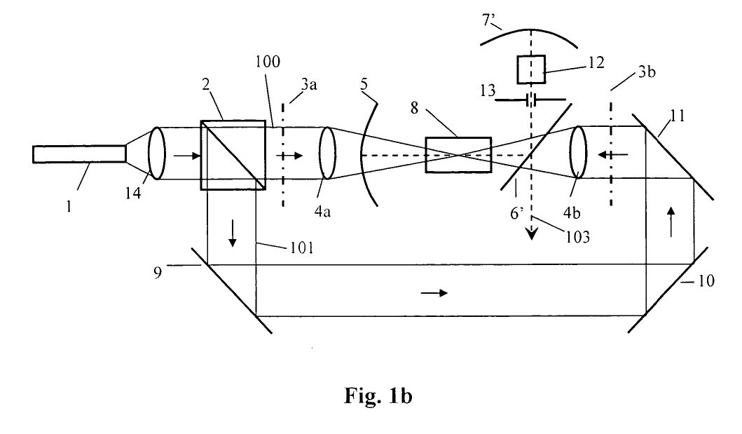

FIG. 1a shows a laser cavity including three mirrors 5, 6, 7, a gain medium 8 and a single optical waveguide 1.

The optical waveguide I is an optical fibre. The optical waveguide is the sole means of introducing pump light into the laser cavity. Light from the optical fibre 1 is utilised to optically pump both ends of the gain medium.

Pump light output from the fibre 1 is split into two portions 100, 101 by beam splitter 2. Beam splitter 2 is a polarising beam splitter, such that each of the two portions 100, 101 is linearly polarised. The two portions are orthogonally polarised. Lens 14 is placed in the optical path between the beam splitter 2 and the optical fibre 1, for collimation of the pump light prior to splitting.

Each pump light portion 100, 101 is directed into a respective, different face of a gain medium. In this particular embodiment, only a single gain medium is utilised. The pump light portions 100, 101 are directed into opposite faces of the gain medium 8.

Lens 4a is placed in the optical path of polarised beam portion 100 (between the beam splitter 2 and the gain medium 8) to focus the collimated polarised beam portion 100 into the gain medium 8. Similarly, lens 4b is placed in the optical path of radiation beam portion 101, to focus the collimated radiation beam into the opposite surface of the laser gain medium 8.

In this particular embodiment, a respective polarisation altering device is placed within the optical path of each of the polarised radiation beam portions 100, 101. Each polarisation altering device is arranged to alter the polarisation direction of the incident radiation beam. The polarisation altering devices are utilised to alter the linear polarisation angle relative to the axes of the laser gain medium 8. In this particular embodiment, the polarisation altering devices are half-wave-plates 3a, 3b. It will be appreciated that provision of a polarisation altering device within an optical path of the pump light portion is optional - the polarisation direction of the pump light output from the polarising beam splitter will, in some embodiments, not require alteration.

Polarised pump beam portion 100 is directed along an optical path through the half-wave-plate 3a, and is focussed through one of the laser cavity mirrors (5) by lens 4a, into the gain medium 8.

Beam steering mirrors 9, 10 and 11 are utilised to direct pump radiation beam portion 101 along an optical path into the opposite face of the gain medium 8. Portion 101 is directed through half-wave-plate 3b, and focussed through one of the laser cavity mirrors (6) by lens 4b, into the gain medium 8.

Examples of suitable gain medium 8 include Nd:YVO₄, Nd:GdVO₄, or Nd:YLF. Laser cavity mirrors 5 and 6 are arranged to substantially reflect the fundamental wavelength of the laser (i.e. the wavelength output from gain medium 8), and to substantially transmit the wavelength of the pump radiation beam.

Mirrors 5, 6 and 7 act to provide a resonant laser cavity for the fundamental laser wavelength. End mirror 7 is arranged to be partially transmissive at the fundamental laser wavelength, such that a predetermined incident portion of light at the fundamental wavelength is transmitted through the mirror 7 to provide the laser output 102. Mirrors 5 and 7 act as end mirrors, and are curved. The laser cavity is formed as a dog leg, with an end mirror 5, 7 at each end, and mirror 6 being arranged at an angle of substantially 45° to the respective optical axis of both end mirrors 5, 7 to act as a fold mirror.

Laser gain medium 8 is thus optically pumped through two different faces with linearly polarised radiation pump beams, despite the polarisation of the pump light output from the optical fibre 1 being a mix of polarisation states. Utilising polarisation altering devices, the polarisation states of each of the pump light portions can be individually altered as appropriate.

In this embodiment, it is assumed that the gain medium 8 is birefringent e.g. it has different absorption depths for different polarisation directions. The half-wave-plates 3a, 3b are thus arranged to alter the polarisation direction of each of the two pumping beam portions, so as to optimise the average absorption depth of each beam within the gain medium 8.

As different axes of the birefringent material may have different absorption coefficients, altering the polarisation of a linearly polarised beam relative to the different axes will result in different proportions of the polarised beam being absorbed along each axis, and at different depths within the gain medium. Thus, by rotating the polarisation direction of the incident beam portion, the average absorption depth of the polarised beam within the gain medium can be altered. The polarisation direction of the pump beam portion is altered, using the polarisation altering device, so as to provide a desired average absorption depth of that beam within the gain medium e.g. to optimise the thermal absorption profile inside the gain medium.

Such alteration of the polarisation direction of each pump beam portion can be performed during the manufacture of the device. Equally, the laser head may be configured to allow adjustment of the polarisation of the different pump beam portions, during use of the solid state pumped laser.

FIG. 1b illustrates an alternative cavity arrangement, arranged to provide an output wavelength approximately half that of the fundamental laser wavelength. The configuration of the cavity in FIG. 1b is generally similar to that shown in FIG. 1a, and hence will not be described again in detail.

In order to change the fundamental laser wavelength output from the laser gain medium 8 to the desired output wavelength, a frequency doubling crystal 12 is provided. The frequency doubling crystal 12 is located within the resonant cavity formed by end mirrors 5, 7′ and fold mirror 6′. In this particular embodiment, fold mirror 6 is arranged as the output mirror, and hence is arranged to transmit a predetermined portion of the frequency doubled radiation. End mirror 7′ is therefore arranged to reflect substantially all of the fundamental laser wavelength. The resulting laser cavity output light 103 through mirror 6′, at the frequency doubled wavelength, is indicated by arrow 103.

In this particular embodiment shown in FIG. 1b, the waist of the laser mode is preferably chosen to be in or near the frequency doubling crystal 12. The frequency doubling process is a non-linear process, that requires high intensities of the fundamental laser light in order to be efficient. Thus, the beam waist of the fundamental laser mode is chosen to be adjacent or within the frequency doubling crystal 12, so as to maximise the intensity of the fundamental wavelength within the frequency doubling crystal, and so to maximise efficiency of the frequency doubling process.

In this particular embodiment an intra-cavity aperture 13 is located within the cavity formed by end mirrors 5, 7′. The aperture 13 is located along the optical path between the gain medium 8 and the frequency doubling crystal 12. The aperture 13 is defined by a plate. The aperture is located and sized to cause high optical losses to the higher order laser modes, so as to prevent the higher order laser modes lasing. Thus, with a suitable choice of aperture size, the laser output can be constrained to a low order or fundamental TEM₀₀ spatial mode profile.

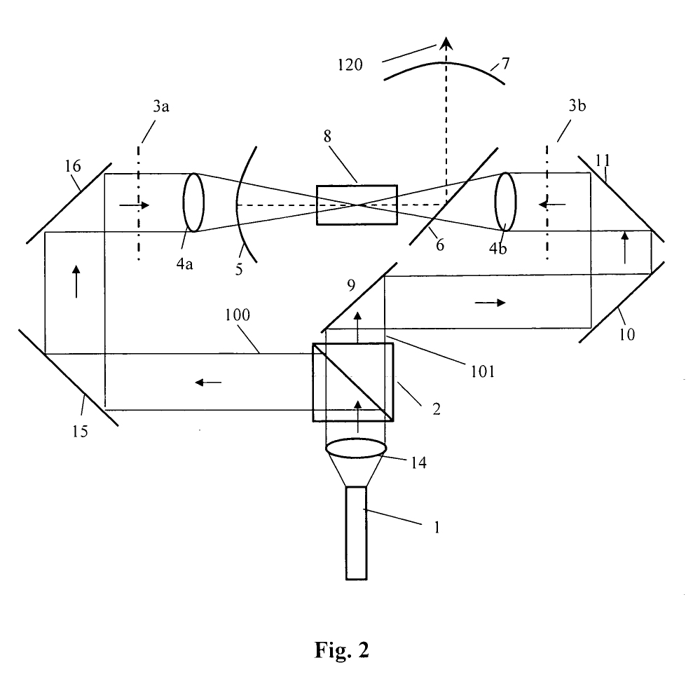

FIG. 2 shows an alternative embodiment of the present invention, utilising symmetrical pump portion path lengths. The configuration is generally similar to that illustrated in FIG. I a. However, the laser head is configured to ensure that each portion of pump light experiences the same optical path length, prior to being incident upon the laser gain medium 8.

In the configuration shown in FIGS. 1a and 1b, one of the portions of pump light (100) is directed into the gain medium 8, without reflection from- any surface. The other portion of pump light in those FIGS. 1a, 1b, is directed around a relatively circuitous route by deflecting mirrors 9, 10, 11, and hence into the opposite face of the gain medium 8.

In the configuration shown in FIG. 2, pump light output from optical fibre 1 is directed into a polarising beam splitter 2 located adjacent the gain medium 8.

Locating the polarising beam splitter adjacent the gain medium 8 allows a similar optical path length to be traversed by each portion 100, 101 of the radiation beam (light), with the total optical path lengths traversed by any portion 100, 101 prior to entering the gain medium 8, being minimal. Thus, pump radiation portion 100 from polarising beam splitter 2 is reflected by beam deflecting mirrors 15, 16 into a first face of gain medium 8. Similarly, pump radiation beam portion 101 is directed by deflecting mirrors 9, 10 and 11 into a second, opposite face of gain medium 8. The beam deflecting mirrors 9, 10, 11 and 15, 16 are located so as to minimise the respective optical paths of each pump light portion between the beam splitter 2 and gain medium 8.

The configuration illustrated in FIG. 2 is suitable for applications in which the pump radiation beam has a relatively low spatial quality. Such a low spatial quality makes the pump beam (and the pump beam portions) difficult to direct over longer distances, without the beam significantly diverging (and thus requiring additional lenses located within the beam path to keep the beam diameter to the desired, small size). For example, it will be observed that the optical paths experienced by either beam portion 100, 101 in FIG. 2 is less than the relatively long optical path experienced by beam portion 101 in FIG. 1a.

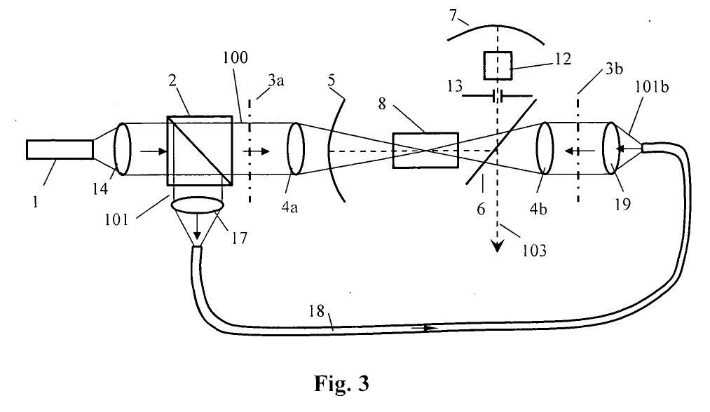

FIG. 3 shows another arrangement in accordance with a further embodiment of the present invention. The arrangement is generally similar to that shown in FIG. 1b. As previously, identical reference numerals are utilised to illustrate similar features. The position and the operation of those similar features is hence not described again in detail.

In the embodiment shown in FIG. 1b, pump light portion 101 from beam splitter 2 was directed into the relevant face of optical gain medium 8 via beam deflecting mirrors 9, 10 and 11. In this particular embodiment illustrated in FIG. 3, a single optical fibre 18 performs the function of those beam deflecting mirrors. It should be noted that the single optical fibre 18 is distinct from the optical fibre 1 utilised to provide pump radiation to the laser head/overall laser cavity. Optical fibre 18 is wholly located within the laser head, and is simply used to re-direct light within the laser head.

To facilitate the coupling of the pump radiation portion 101 into the optical fibre 18, portion 101 is focussed by lens 17 into one end of optical fibre 18. The divergent pump light portion 101b output from optical fibre 18 is directed through lens 19, to collimate the divergent beam 101b. The collimated beam is directed through polarisation altering device 3b to alter the polarisation of the beam, prior to being focussed on/into the gain medium 8 by lens 4b.

Light 101 focussed into the optical fibre 18 is linearly polarised, whilst it will be appreciated that the light 101b output from the optical fibre is likely to be partially depolarised by the fibre. Despite this, the half-wave-plate 3b will still have a significant effect on the polarisation of light entering the gain medium, as the light 101b output from the optical fibre will not be completely depolarised.

In the above embodiments, a single optical fibre has been utilised to introduce pump light to the cavity arrangement, with the cavity arrangement including a single gain medium. However, it will be appreciated that other embodiments would fall within the scope of the present invention. For example, two optical fibres could be utilised to introduce pump light to the laser cavity configuration, with the pump light output from each fibre being each split into two respective beam portions. For example, pump light output from a first pump fibre could be split into two portions, the first portion being directed into a first face of a first gain medium, and a second portion being directed into a first face of a second gain medium. Similarly, pump light output from the second fibre could be split into two respective portions, with each of those portions directed into different faces of the first and second gain media.

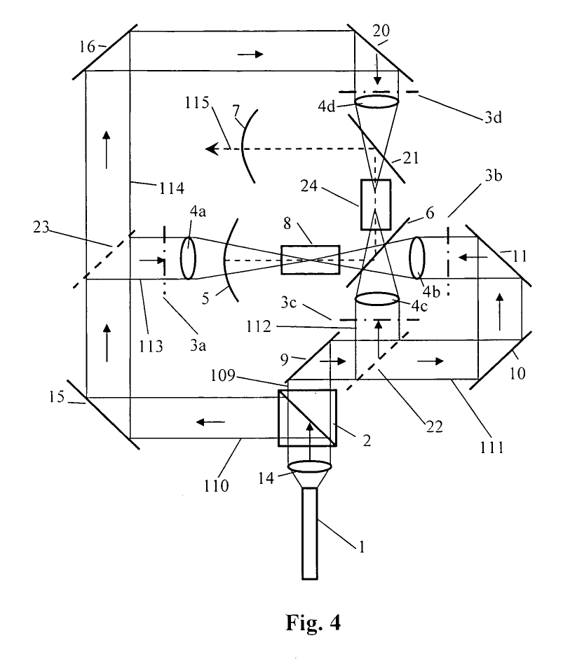

FIG. 4 shows an alternative embodiment, in which two laser gain media 8, 24 are each both end-pumped by pump light originating from a single optical fibre.

The divergent pump light output from optical fibre 1 is collimated by lens 14, and directed into polarising beam splitter 2. Polarising beam splitter 2 splits the incident, unpolarised pump beam into two linearly polarised portions 109, 110.

Each of the collimated polarised pump radiation beam portions 109, 110 is then split into two sub-portions by a respective beam splitter 22, 23 placed in the respective optical beam paths. Beam splitters 22, 23 are non-polarising.

Each pump light sub-portion 111, 112, 113 and 114 is then directed into a separate, different face of a gain medium 8, 24. Each of the sub-portions of pump radiation 111, 112, 113, 114 is directed through a respective lens 4b, 4c, 4a, 4d, so as to focus the sub-portion into the respective gain medium 8, 24. Further, each of the sub-portions 111, 112, 113 and 114 is of substantially equal power, and each portion is linearly polarised.

In this particular embodiment, each sub-portion 111-114 is directed through a respective polarisation altering device (e.g. half-wave-plate 3a, 3b, 3c and 3d) so as to place the sub-portion in the desired polarisation state when incident upon the relevant gain medium.

Each laser gain medium 8, 24 is located within the laser cavity formed by end mirrors 5, 7 and fold mirrors 6, 21. End mirror 7 acts as the output mirror, and thus is partially transmissive to the fundamental laser wavelength, so as to provide output beam 115. Each of the other cavity mirrors 5, 6, 21 are substantially reflective to the fundamental laser wavelength, and substantially transmissive to pump light radiation wavelengths.

Pump light is directed into the laser cavity through the cavity mirrors 5, 6, 21. For example, laser gain medium 8 is located within the cavity between end mirror 5 and fold mirror 6. A first sub-portion 113 of pump light is thus directed into a first face of gain medium 8 through end mirror 5, and a second sub-portion 111 of pump light is directed into the opposite face of gain medium 8 through fold mirror 6. Similarly, gain medium 24 is located between fold mirrors 6, 21. A sub-portion 114 of the pump light is thus directed into a first face of gain medium 24 through fold mirror 21, and another sub-portion 112 of pump light directed into the opposite face of gain medium 24 through fold mirror 6.

Thus, two Sub-portions of pump beam radiation are incident upon each gain medium 8, 24. The sub-portions of pump beam radiation are incident upon opposite faces of each gain medium. The laser cavity configuration further comprises beam steering mirrors 9, 10, 11, 15, 16 and 20 for appropriate direction of the pump beam portions and sub-portions.

Using such a configuration, as illustrated in FIG. 4, a single optical fibre can be utilised to pump two, separate laser gain media. Such a geometrical arrangement allows the efficient provision of pump light to both gain media.

Although there has been hereinabove described a laser cavity pumping configuration, for the purpose of illustrating the manner in which the invention may be used to advantage, it should be appreciated that the invention is not limited thereto. Accordingly, any and all modifications, variations, or equivalent arrangements which may occur to those skilled in the art, should be considered to be within the scope of the present invention as defined in the appended claims.

What is claimed is:

1. A laser cavity comprising:
at least a first mirror and a second mirror;
at least one gain medium located on an optical path between said mirrors;
an optical waveguide for providing pump light; and
at least one beam splitter arranged to split the pump light from the optical waveguide into at least a first portion and a second portion, and direct each portion along an optical path that leads into a respective, different, face of said at least one gain medium.

2. A laser cavity according to claim 1, wherein said first and second portions of the pump light are directed into opposing surfaces of one of said at least one gain medium.

3. A laser cavity according to claim 1, wherein one of said portions of the pump light is directed into a surface of a first gain medium, and another of said portions is directed into a surface of a second gain medium.

4. A laser cavity according to claim 1, wherein said beam splitter is a polarising beam splitter arranged to split the pump light into the first portion having a first polarisation, and the second portion having a second, different polarisation.

5. A laser cavity according to claim 1, comprising another optical waveguide arranged to transport at least one of said portions of said pump light for directing that portion into said one of said faces.

6. A laser cavity according to claim 1, comprising a further pump optical waveguide for providing a further pump light to the laser cavity, said at least one beam splitter being arranged to split this further pump light into at least a further two portions, and direct each of these further portions along an optical path into a respective, different face of said at least one gain medium.

7. A laser cavity according to claim 1, wherein at least one of said gain medium is a birefringent crystal having a first axis with a first absorption coefficient, and a second axis with a second, different absorption coefficient for the pump light.

8. A laser cavity according to claim 7, wherein said birefringent crystal is doped with at least one of Neodymium and Ytterbium, the birefringent material comprising at least one of: YVO₄, GdVO₄, and YLF.

9. A laser cavity according to claim 1, further comprising a non-linear frequency doubling crystal arranged to frequency double the fundamental laser light output by the gain medium.

10. An apparatus comprising a laser cavity, the laser cavity comprising:
at least a first mirror and a second mirror;
at least one gain medium located on an optical path between said mirrors;
an optical waveguide for providing pump light; and
at least one beam splitter arranged to split the pump light from the optical waveguide into at least a first portion and a second portion, and direct each portion along an optical path that leads into a respective, different, face of said at least one gain medium.

11. An apparatus as claimed in claim 10, wherein the apparatus comprises a second laser, the laser cavity being arranged to provide an output beam for pumping the second laser.

12. A method of manufacturing a laser cavity comprising:
providing at least a first mirror and a second mirror;
providing at least one gain medium located on an optical path between said mirrors;
providing an optical waveguide for providing a pump light;
locating at least one beam splitter to split the pump light from the optical waveguide into at least a first portion and a second portion, and to direct each portion along an optical path that leads into a respective, different face of said at least one gain medium.

13. A method according to claim 12, comprising:
adjusting the polarisation of at least one of the portions of the pump light incident upon said gain medium, for optimising the average absorption depth of the pump light within the gain medium.

14. A method as claimed in claim 13, wherein the polarisation is adjusted by altering the orientation of a wave-plate within the optical path of said portion.

15. A method according to claim 12, wherein said gain medium comprises a birefringent crystal, the method comprising:
configuring the polarisation of two portions of said pump light incident upon opposite surfaces of the crystal, so as to have the same proportion of components along the a-axis and c-axis of the crystal, the portions thereby experiencing the same average absorption depth within said crystal.

16. A method according to claim 12, wherein said gain medium comprises a birefringent crystal, the method comprising:
configuring the polarisation of one of said portions of the pump light incident upon a surface of the crystal to be substantially parallel to at least one of the a-axis and the b-axis of the crystal, thereby maximising the absorption depth of that portion within said crystal.

17. An apparatus according to claim 10, wherein said first and second portions of the pump light are directed into opposing surfaces of one of said at least one gain medium.

18. An apparatus according to claim 10, wherein one of said portions of the pump light is directed into a surface of a first gain medium, and another of said portions is directed into a surface of a second gain medium.

19. An apparatus according to claim 10, wherein said beam splitter is a polarising beam splitter arranged to split the pump light into the first portion having a first polarisation, and the second portion having a second, different polarisation.
